(19) United States
(12) Patent Application Publication
(10) Pub. No.: US 2015/0081418 A1
(43) Pub. Date: Mar. 19, 2015

(54) PLATFORMS AND SOFTWARE FOR JUST-IN-TIME MARKETING OF ATTRACTIONS

(71) Applicant: Fun Things, Inc., Redwood City, CA (US)

(72) Inventor: Anil Kumar Sahai, Saratoga, CA (US)

(73) Assignee: Fun Things, Inc., Redwood City, CA (US)

(21) Appl. No.: 14/046,713

(22) Filed: Oct. 4, 2013

Related U.S. Application Data
(60) Provisional application No. 61/879,430, filed on Sep. 18, 2013.

(51) Int. Cl. G06Q 30/02

(52) U.S. Cl. CPC G06Q 30/0259
USPC 705/14.41

(57) ABSTRACT

A platform comprising an enterprise application, a mobile application and a server application configured for attractions to deliver timely marketing, advertising and promotions messages to targeted individuals.

### CROSS REFERENCE TO RELATED APPLICATIONS

This application claims the benefit of U.S. Application Ser. No. 61/879,430, filed Sep. 18, 2013, which is hereby incorporated by reference in its entirety.

### BACKGROUND OF THE INVENTION

Clients of local business vendors or attractions are largely the local ones, either residing in the neighborhood or visiting to the vicinity. Current methods of marketing, advertising and promotions, e.g., press advertisements and online advertisements, of the vendors and attractions lack effectiveness in precisely targeting the local clients and timely delivering advertisements to them. The problem is mainly due to the passive delivery of the methods, leading to a waste of marketing resources.

### SUMMARY OF THE INVENTION

Advantages of this invention allow vendors and attractions to deliver just-in-time marketing, information, sales announcements, advertisements, and event notifications to the targeted clients. Utilizing modern mobile technologies and ubiquitous networks, the vendors and attractions can exploit mobile applications to gather the information about who the mobile users are, whom the mobile user are with, where the mobile users are, where the mobile users are going, what the mobile users are doing, and what the mobile users have interests in. The mobile application can track the locations of mobile users and gather their companion and travel information. Analysis of the locations and the information can profile the mobile users in a greater detail and individualize the marketing, advertising and promotions strategies with a higher precision. This invention utilizes the analysis results to create a marketing, advertising and promotions message being timely delivered to the mobile users via a push notification without any user request. In particular, active delivery of marketing, advertising and promotions messages is a leverage to amplify the power of the targeted marketing efforts. The subject matter described herein allows vendors and attractions to increase the hitting rates of their marketing, advertising and promotions messages and improve the return on their marketing investments.

In one aspect, disclosed herein is a platform comprising: a processor configured to provide an enterprise user with an enterprise application including a software module for configuring marketing, advertising and promotions information of an attraction and a software module for summarizing the effectiveness of one or more marketing, advertising and promotions messages of the attraction; a mobile processor configured to provide a mobile user with a mobile application including a software module for tracking the location of the mobile user, a software module for receiving demographic information of the mobile user, a software module for gathering companion information of the mobile user, a software module for receiving a marketing, advertising and promotion message of an attraction; and a server provide a server application including a software module for receiving and storing the marketing, advertising and promotions information of one or more attractions where the marketing, advertising and promotions information provided by the one or more attractions through the enterprise application, a software module for receiving and storing the location where the demographic information and the companion information of the mobile user, the location, the demographic information and the companion information provided by the mobile user through the mobile application, a software module for creating a marketing, advertising and promotions message by analyzing the location, the demographic information and the companion information of the mobile user and analyzing the marketing, advertising and promotions information in the vicinity of the mobile user, a software module for timely delivering a push notification to the mobile user where the push notification containing the marketing, advertising and promotions message, and a software module for measuring the effectiveness of the marketing, advertising and promotions message by analyzing the behavior of the mobile user after receiving the marketing, advertising and promotions message.

In another aspect, disclosed herein are non-transitory computer-readable storage media encoded with a computer program including instructions executable by a mobile processor to create a mobile application comprising a software module for tracking the location of a mobile user, a software module for receiving the demographic information of the mobile user, a software module for gathering the companion information of the mobile user, a software module for receiving a marketing, advertising and promotions message of an attraction, and a software module for receiving a suggested attraction provided by the mobile user.

In another aspect, disclosed herein are non-transitory computer-readable storage media encoded with a computer program including instructions executable by a server processor to create a server application comprising: a software module for receiving and storing the marketing, advertising and promotions information of one or more attractions, the marketing, advertising and promotions information provided by the one or more attractions; a software module for receiving and storing the location, the demographic information and the companion information of a mobile user, the location, the demographic information and the companion information provided by the mobile user through a mobile application; a software module for creating a marketing, advertising and promotions message by analyzing the location, the demographic information and the companion information of the mobile user and analyzing the marketing, advertising and promotions information in the vicinity of the mobile user; a software module for timely delivering a push notification to the mobile user, the push notification containing the marketing, advertising and promotions message; and a software module for measuring the effectiveness of the marketing, advertising and promotions message by analyzing the behavior of the mobile user after receiving the marketing, advertising and promotions message.

### BRIEF DESCRIPTION OF THE DRAWINGS

FIG. 1 shows a non-limiting example of a schematic diagram of a platform; in this case, the platform comprises: an enterprise application for handling marketing, advertising and promotions information and databases, a mobile application for handling the information of mobile user, and a server application for receiving, storing, and processing all the information and for delivering marketing, advertising and promotions messages to the mobile application.

FIG. 2 shows a non-limiting example of a user interface for entering companion information; in this case, the companion information can be entered by pressing buttons “I′m in my hood,” “I′m with my hottie,” “I′m with my family,” and/or “I′m traveling”.

FIG. 3 shows a non-limiting example of a marketing, advertising and promotions message in the form of a map; in this case, a map of attractions in the vicinity of Reno-Tahoe International Airport, Nev. is displayed.

FIG. 4 shows a non-limiting example of a marketing, advertising and promotions message in the form of text description; in this case, the marketing, advertising and promotions message describes the business information of Wild Island Family Adventure Park.

FIG. 5 shows a non-limiting example of a marketing, advertising and promotions message of a selected attraction; in this case, the marketing, advertising and promotions message displays Horn Blower Cruises & Events on the map of San Francisco, Calif.

FIG. 6 shows a non-limiting example of a marketing, advertising and promotions message; in this case the marketing, advertising and promotions message displays the business information and event information of Horn Blower Cruises & Events.

FIG. 7 shows a non-limiting example of a user interface for entering a trip destination; in this case, the mobile user entered Anaheim, Calif.

FIG. 8 shows a non-limiting example of a marketing, advertising and promotions message in response to an entered trip destination “Anaheim, Calif.”; in this case a map of attractions in the vicinity of Anaheim, Calif. is displayed.

FIG. 9 shows a non-limiting example of a marketing, advertising and promotions message in response to an entered trip destination “Anaheim, Calif.”; in this case a list of attractions in the vicinity of Anaheim, Calif. is displayed.

FIG. 10 shows a non-limiting example of a marketing, advertising and promotions message; in this case the marketing, advertising and promotions message suggests Disneyland Park on top of the map of Anaheim, Calif.

FIG. 11 shows a non-limiting example of a user interface of making referral; in this case the mobile user can enter referees of potential mobile users through social media.

FIG. 12 shows a non-limiting example of a user interface of making referral; in this case the mobile user can enter a recommended attraction.

FIG. 13 shows a non-limiting example of the platform acknowledging the referral; in this case, a $25 of referral fee might be awarded to the mobile user for making a referral.

### DETAILED DESCRIPTION OF THE INVENTION

Clients of local business vendors or attractions are largely the local ones, either residing in the neighborhood or visiting to the vicinity. Current methods of marketing, advertising and promotions, e.g., press advertisements and online advertisements, of the vendors and attractions lack effectiveness in precisely targeting the local clients and timely delivering advertisements to them. The problem is mainly due to the passive delivery of the methods, leading to a waste of marketing resources.

Advantages of this invention allow vendors and attractions to deliver just-in-time marketing, advertising and promotions information, sales announcements, advertisements, and event notifications to the targeted clients. Utilizing modern mobile technologies and ubiquitous networks, the vendors and attractions can exploit mobile applications to gather the information of who the mobile users are, whom the mobile user are with, where the mobile users are, where the mobile users are going, what the mobile users are doing, and what the mobile users have interests in. The mobile application can track the locations of mobile users and gather their companion and travel information. Analysis of the locations and the information can profile the mobile users in a greater detail and individualize the marketing, advertising and promotions strategies with a higher precision. The subject matter described herein utilizes the analysis results to create a marketing, advertising and promotions message being timely delivered to the mobile users via a push notification without any user request. In particular, active delivery of marketing, advertising and promotions messages is a leverage to amplify the power of the targeted marketing efforts. The subject matter described herein allows vendors and attractions to increase the hitting rates of their marketing, advertising and promotions messages and improve the return on their marketing investments.

Described herein, in various embodiments, is a just-in-time marketing, advertising and promotions platform comprising: a processor configured to provide an enterprise user with an enterprise application including a software module for configuring marketing, advertising and promotions information of an attraction and a software module for summarizing the effectiveness of one or more marketing, advertising and promotions messages of the attraction; a mobile processor configured to provide a mobile user with a mobile application including a software module for tracking the location of the mobile user, a software module for receiving demographic information of the mobile user, a software module for gathering companion information of the mobile user, a software module for receiving a marketing, advertising and promotions message of an attraction; and a server provide a server application including a software module for receiving and storing the marketing, advertising and promotions information of one or more attractions where the marketing, advertising and promotions information provided by the one or more attractions through the enterprise application, a software module for receiving and storing the location where the demographic information and the companion information of the mobile user, the location, the demographic information and the companion information provided by the mobile user through the mobile application, a software module for creating a marketing, advertising and promotions message by analyzing the location, the demographic information and the companion information of the mobile user and analyzing the marketing, advertising and promotions information in the vicinity of the mobile user, a software module for timely delivering a push notification to the mobile user where the push notification containing the marketing, advertising and promotions message, and a software module for measuring the effectiveness of the marketing, advertising and promotions message by analyzing the behavior of the mobile user after receiving the marketing, advertising and promotions message.

Also described herein, in various embodiments, are non-transitory computer-readable storage media encoded with a computer program including instructions executable by a mobile processor to create a mobile application comprising a software module for tracking the location of a mobile user, a software module for receiving the demographic information of the mobile user, a software module for gathering the companion information of the mobile user, a software module for receiving a marketing, advertising and promotions message of an attraction, and a software module for receiving a suggested attraction provided by the mobile user.

Also described herein, in various embodiments, are non-transitory computer-readable storage media encoded with a computer program including instructions executable by a server processor to create a server application comprising: a software module for receiving and storing the marketing, advertising and promotions information of one or more attractions, the marketing, advertising and promotions information provided by the one or more attractions; a software module for receiving and storing the location, the demographic information and the companion information of a mobile user, the location, the demographic information and the companion information provided by the mobile user through a mobile application; a software module for creating a marketing, advertising and promotions message by analyzing the location, the demographic information and the companion information of the mobile user and analyzing the marketing, advertising and promotions information in the vicinity of the mobile user; a software module for timely delivering a push notification to the mobile user, the push notification containing the marketing, advertising and promotions message; and a software module for measuring the effectiveness of the marketing, advertising and promotions message by analyzing the behavior of the mobile user after receiving the marketing, advertising and promotions message.

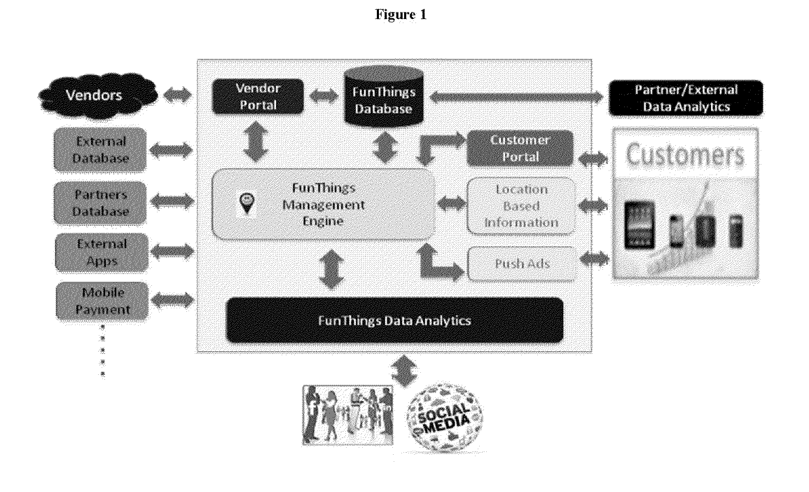

Referring to FIG. 1, in a particular embodiment, a platform may comprise an enterprise application receiving the marketing, advertising and promotions information of vendors/attractions and sending the information to a server, a mobile application on a mobile device receiving the mobile users' information and sending it to a server, and a server application running a management engine to handle the information from vendors/attractions and mobile users. Upon receiving a piece of new information, the server may store it in a database, and the management engine may instantly analyze the characteristics of mobile users and find any marketing, advertising and promotions information suitable for the mobile users. When suitable marketing, advertising and promotions information is found, the server instantly sends a push notification containing a marketing, advertising and promotions message to the mobile users. Meanwhile, the server may start to track the behavior of the mobile users to evaluate the effectiveness of the marketing, advertising and promotions message. A module of data analytics may summarize the effectiveness and provide the feedback to the management engine to assess the effectiveness of the marketing, advertising and promotions strategies. Furthermore, the enterprise application may offer vendors/attractions a real-time operation mode to see the potential customers in the vicinity and then to deliver instant marketing, advertising and promotions messages to these customers. In this embodiment, the server may integrate social media where the mobile users can recommend vendors/attractions or can refer other mobile users, e.g., friends and family members, to use the mobile application.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Enterprise Application

In some embodiments, the enterprise application comprises an interface for a staff member of an attraction to enter the marketing, advertising and promotions information, and transmits the information to the server. In some embodiments, the enterprise application comprises a software module for recommending a marketing, advertising and promotions strategy to attractions; a staff member of an attraction using the enterprise application may adopt the marketing, advertising and promotions strategy to enter marketing, advertising and promotions information. In some embodiments, the enterprise application provides an effectiveness report of the past marketing, advertising and promotions information or strategies to the staff member of an attraction operating the enterprise application. In some embodiments, the enterprise application can comprise a software module for processing billing and payment of the attraction for using the enterprise application and the marketing, advertising and promotions platform.

The platform described herein may monitor the use of marketing, advertising and promotions messages delivered to mobile users. The monitoring schemes may include tracking and analyzing the behaviors of the mobile user after receiving a marketing, advertising and promotions message. In some embodiments, the platform tracks if the mobile user enters an attraction, redeems a coupon, likes the suggested attractions, or attends an event. Alternatively, the platform may include a software module which receives feedbacks from mobile users regarding the marketing, advertising and promotions messages. A server may perform analysis on the user behaviors and feedbacks to summarize analytics on the marketing effectiveness. The effectiveness not only gives a ground to evaluate the success of the past market, advertising, and promotions strategies, but also can be used to create a new set of market, advertising, and promotions strategies for enterprise users.

### Attractions

In some embodiments, non-limiting examples of attractions are stores, vendors, restaurants, museums, hotels, aquaria, zoos, malls, recreation centers, landmarks, beaches, stations, amusement parks, national parks, botanical gardens, casinos, castles, festivals, forts, heritage railways, fairs, resorts, ski areas, sports facilities, stadiums, ball games, clinics, hospitals, universities, schools, companies, parking facilities, and cities.

### Marketing, Advertising and Promotions Information

In some embodiments, the platforms, systems, software applications, media, and methods described herein comprise a software module to receive marketing, advertising and promotions information provided by an attraction. Described herein, marketing, advertising and promotions information may include a location of the attraction and a business category of the attraction. In some embodiments, the marketing, advertising and promotions information further comprises an event announcement, a product on sale, an advertisement, a coupon, or a combination of the same.

### Mobile Application

In some embodiments, the platforms, systems, software applications, media, and methods described herein comprise a mobile application comprising a software module for tracking the location of the mobile user and transmitting the location to the server, a software module for receiving demographic information of the mobile user and transmitting the demographic information to the server, and a software module for gathering companion information of the mobile user and transmitting the companion information to the server. In some embodiments, the mobile application comprises a software module for receiving a marketing, advertising and promotions message of an attraction from the server.

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via a computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Companion Information

In some embodiments, the platforms, systems, software applications, media, and methods described herein comprise a software module to gather companion information of the mobile user. The companion information may indicate the mobile user is alone or is with a companion. In some embodiments, a companion is, by way of a non-limiting example, a friend, a family member, a child, a significant other, a colleague, a classmate, a coworker, a business partner, a professional, a teacher, a student, a government officer, a client, a contractor, a supplier, a team, a group, an association, an organization, a pet, or a combination of the same. In some embodiments, the companion information is entered by the mobile user. Alternatively, the platforms, systems, software applications, media, and methods described herein may comprise a software module to automatically detect and identify companions traveling with the mobile user. In some embodiments, the companion information contains the purpose of the trip, by way of a non-limiting example, such as a vacation or a business trip. The companion information may contain the destination of the trip, by way of non-limiting examples, such as a city, an address, and a location.

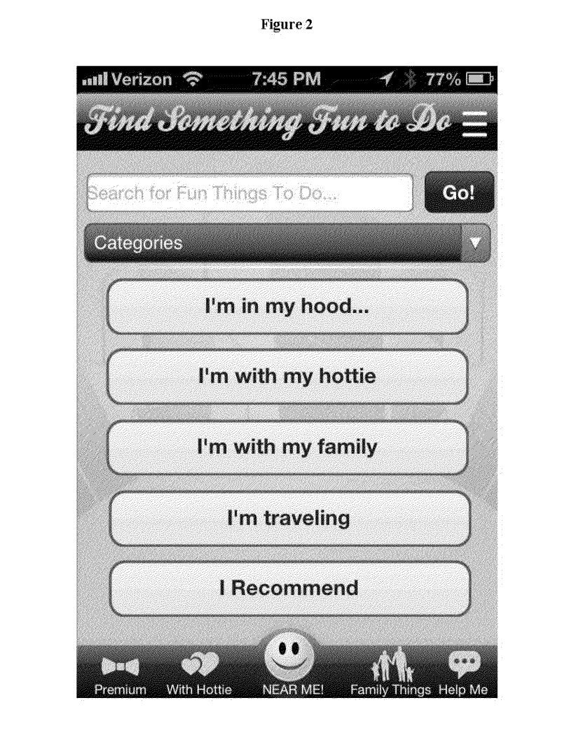

Referring to FIG. 2, in a particular embodiment, a software module gathers companion information of a mobile user. The interface of the software module offers, by way of non-limiting examples, “I′m with my hottie” and “I′m with my family” buttons to allow the mobile user to select the type of the companion. The interface of the software module includes, by way of a non-limiting example, an “I am traveling” button to indicate the trip information.

### Server Application

In some embodiments, the platforms, systems, software applications, media, and methods described herein comprise a server application comprising: a software module for receiving and storing the marketing, advertising and promotions information of one or more attractions, the marketing, advertising and promotions information provided by the one or more attractions; a software module for receiving and storing the location, the demographic information and the companion information of a mobile user, the location, the demographic information and the companion information provided by the mobile user through a mobile application; a software module for creating a marketing, advertising and promotions message by analyzing the location, the demographic information and the companion information of the mobile user and analyzing the marketing, advertising and promotions information in the vicinity of the mobile user; a software module for timely delivering a push notification to the mobile user, the push notification containing the marketing, advertising and promotions message; and a software module for measuring the effectiveness of the marketing, advertising and promotions message by analyzing the behavior of the mobile user after receiving the marketing, advertising and promotions message. The vicinity of the mobile user, by way of a non-limiting example, may be within a radius of 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, or more miles.

### Marketing, Advertising and Promotions Message

In some embodiments, the platforms, systems, software applications, media, and methods described herein comprise a software module for timely delivering a marketing, advertising and promotions message to the mobile user. The marketing, advertising and promotions message may be presented in a form of a text file, an audio file, an image, a video file, or a combination of the same. The marketing, advertising and promotions message may comprise a map of one or more attractions in the vicinity of the mobile user. The marketing, advertising and promotions message may comprise the location of an attraction in the vicinity of the mobile user. The marketing, advertising and promotions message may comprise an advertisement in the vicinity of the mobile user. The marketing, advertising and promotions message may comprise an event in the vicinity of the mobile user. The marketing, advertising and promotions message may comprise a product on sale in the vicinity of the mobile user. The marketing, advertising and promotions message may comprise a coupon of an attraction in the vicinity of the mobile user.

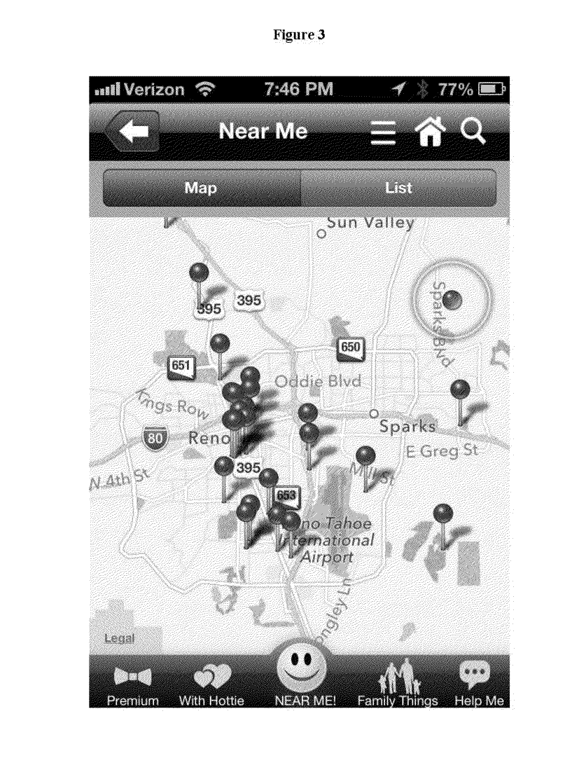

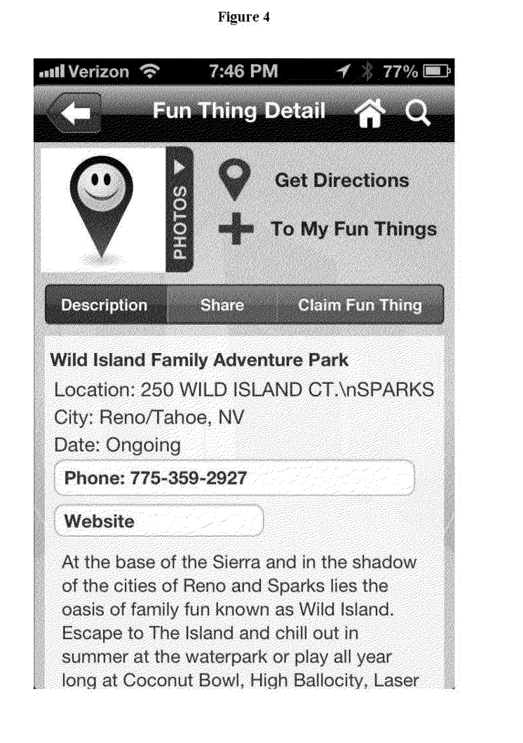

Referring to FIG. 3, in a particular embodiment, a marketing, advertising and promotions message of attractions in the vicinity of the Reno-Tahoe International Airport in Nevada was immediately delivered to a mobile user when the mobile user had arrived the Airport. The marketing, advertising and promotions message was displayed in the form of map. In some embodiments, the mobile user can use the interface to select an attraction to view the details of the attraction. Referring to FIG. 4, in a particular embodiment, the mobile user selected Wild Island Family Adventure Park, and the mobile application displayed the marketing, advertising and promotions information of the Park.

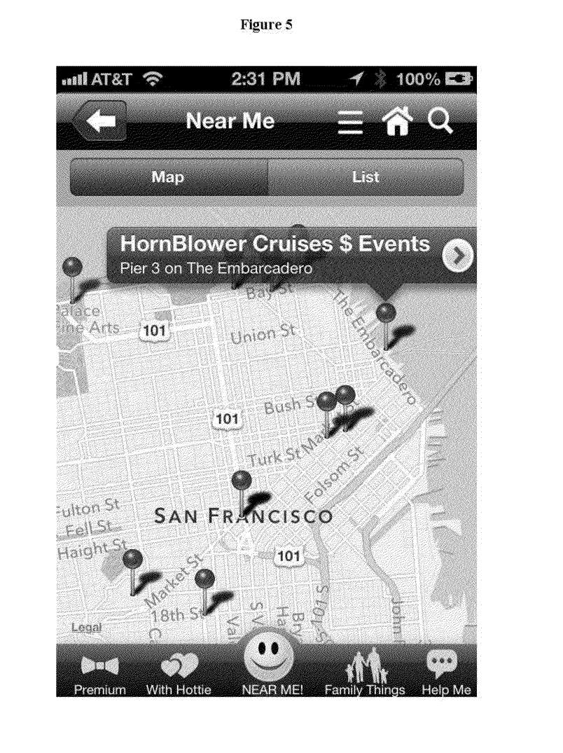

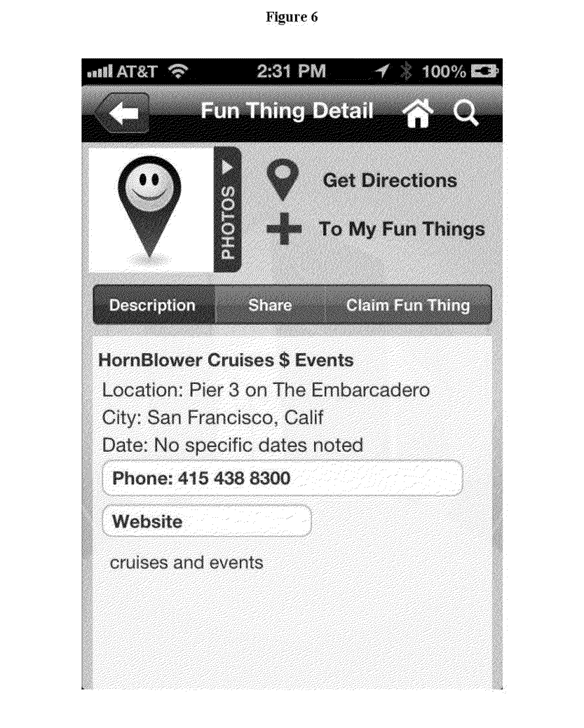

Referring to FIG. 5, in a particular embodiment, a marketing, advertising and promotions message of attractions in the vicinity of the San Francisco, Calif. was immediately delivered to and displayed on a mobile device upon a mobile user traveling in the city. In this embodiment, the marketing, advertising and promotions message was displayed in the form of a map. The mobile user can use the interface to select an attraction to view the details of the attraction. Referring to FIG. 6, in a particular embodiment, the mobile user selected Horn Blower Cruises & Events, and the mobile application displayed the particular marketing, advertising and promotions information of the Horn Blower Cruises & Events. In some embodiments, the marketing, advertising and promotions messages might comprise website links for mobile users to explore more information about the attractions.

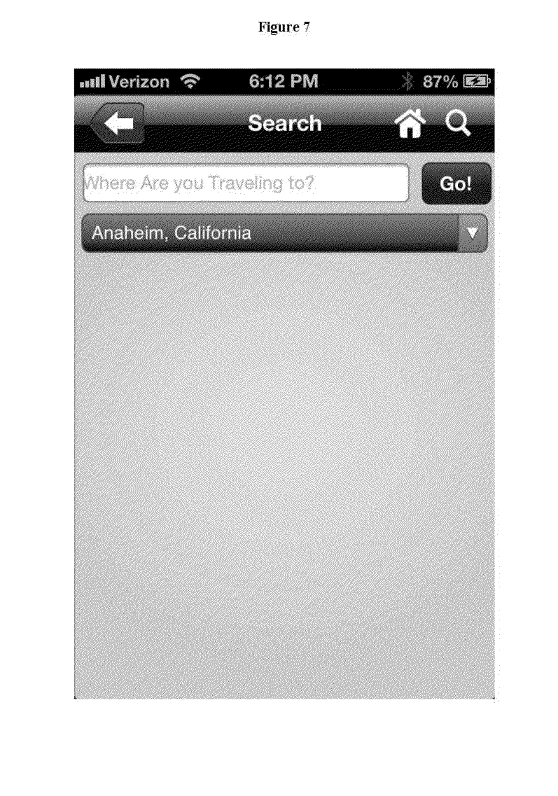

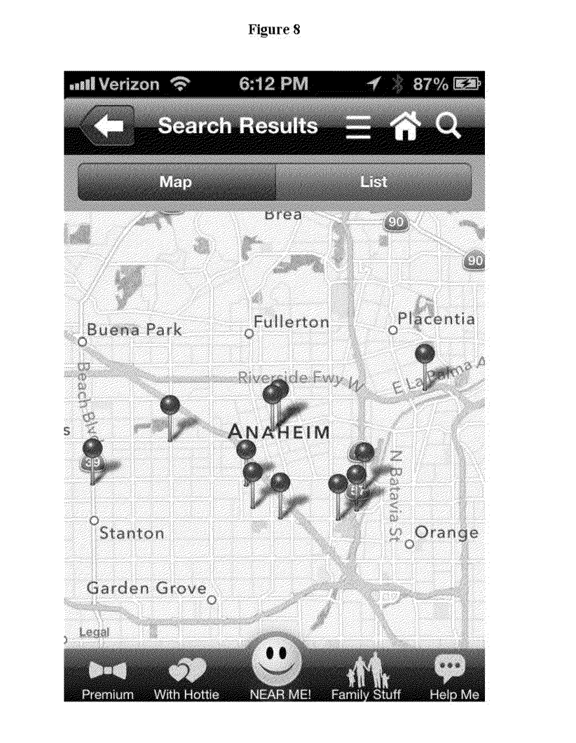

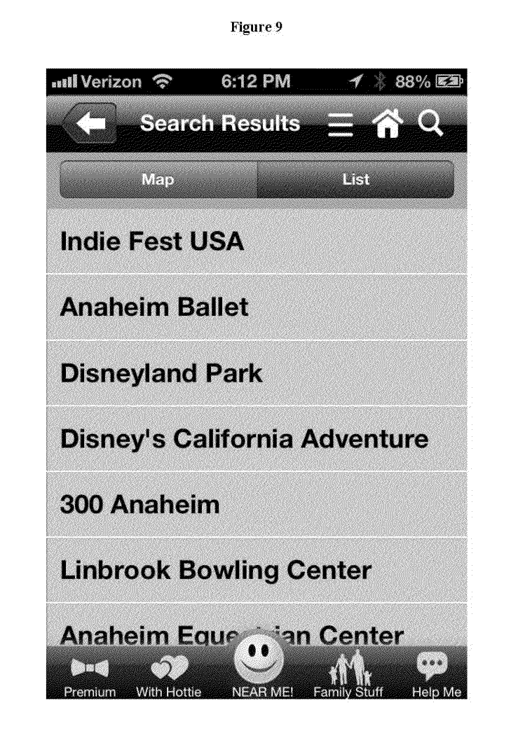

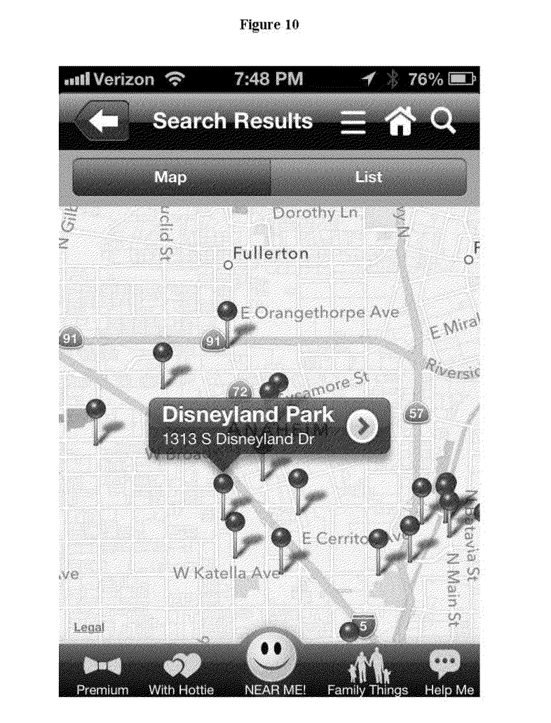

Referring to FIG. 7, in a particular embodiment, the mobile application allows a mobile user to enter the destination of his trip. In this case, the mobile user entered “Anaheim, Calif.” as the destination. The server can respond to this trip information in various modes. In one mode, right after the mobile user entered the destination, the server can deliver a marketing, advertising and promotions message associated with Anaheim, Calif. In another mode, the server may not deliver the marketing, advertising and promotions message to the mobile user until the destination has arrived the vicinity of the mobile user. Referring to FIG. 8, in a particular embodiment, the mobile application received the marketing, advertising and promotions message associated with Anaheim, Calif. and displayed the message in the form of a map; referring to FIG. 9, in another particular embodiment, the mobile application displayed the marketing, advertising and promotions message in the form of a list. Referring to FIG. 10, the mobile application recommended Disneyland Park on the map of Anaheim, Calif.

### Push Notification

In some embodiments, the platforms, systems, software applications, media, and methods described herein comprise a software module for delivering a marketing, advertising and promotions message via a push notification. The push notification described herein is an instant message, without a user request, being real-time distributed to a mobile device by a server upon the trigger of an identified event. In this invention, the server constantly receives the marketing, advertising and promotions information provided by attractions and tracks the locations and companion information of mobile users. Simultaneously, the server is seeking a match between market information and the mobile users. Upon a match found, the server can actively send a push notification containing a marketing, advertising and promotions message to the mobile user. The active push notification can realize just-in-time marketing, advertising and promotions and avoid problems incurred in passive marketing, advertising and promotions schemes, such as pressed advertisements and online advertisements.

### Measuring Effectiveness

In some embodiments, the server application comprises a software module for measuring the effectiveness of the marketing, advertising and promotions message by analyzing the behavior of the mobile user after receiving a marketing, advertising and promotions message. In some embodiments, analyzing the behavior of the mobile user comprises tracking if the mobile user enters the location of the attraction indicated in the marketing, advertising and promotions message. In some embodiments, analyzing the behavior of the mobile user comprises tracking if the mobile user attends the event indicated in the marketing, advertising and promotions message. In some embodiments, analyzing the behavior of the mobile user comprises tracking if the mobile user purchases the product on sale indicated in the marketing, advertising and promotions message. In some embodiments, analyzing the behavior of the mobile user comprises tracking if the mobile user redeems the coupon indicated in the marketing, advertising and promotions message. In some embodiments, analyzing the behavior of the mobile user comprises a combination of the aforementioned schemes.

In addition to actively monitoring the behaviors of the mobile users, the platform described herein may include a software module in the server application or in the mobile application to receive feedback provided by mobile users. The feedback may be the degree of effectiveness of the suggested attractions. The feedback may describe the experiences of using the marketing, advertising, promotions messages to have fun. In some embodiments, the feedback is in a form of text, image, video, audio, or a combination of the same. The server application can perform analysis on the user behaviors and feedbacks to summarize analytics on the effectiveness of marketing, advertising, and promotions. The analysis can be based on simple statistics, by way of non-limiting examples, mean, variance, and ANOVA. Alternatively, the analysis can be achieved by using sophisticated computational models such as intelligent algorithms, machine learning tools, expert systems, or the like. The analysis results can be retrieved by enterprise application users. The effectiveness not only reports the success/failure of the past market, advertising, and promotions strategies, but also may lay a foundation for recommending a new set of market, advertising, and promotions strategies for enterprise users.

### Referral

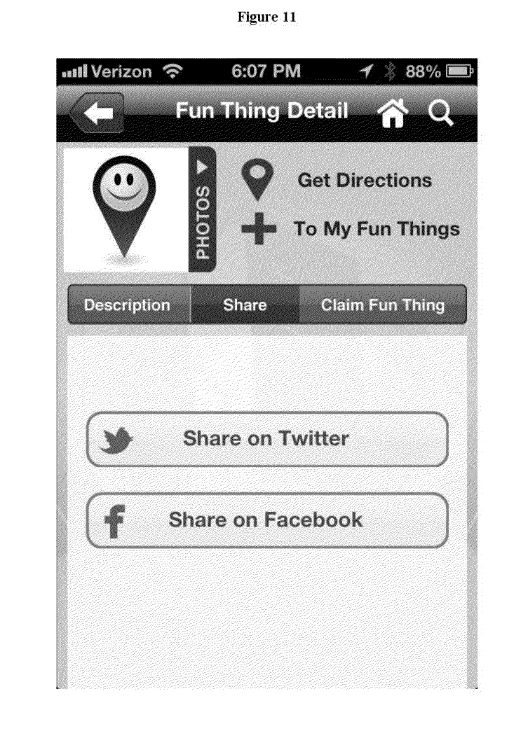

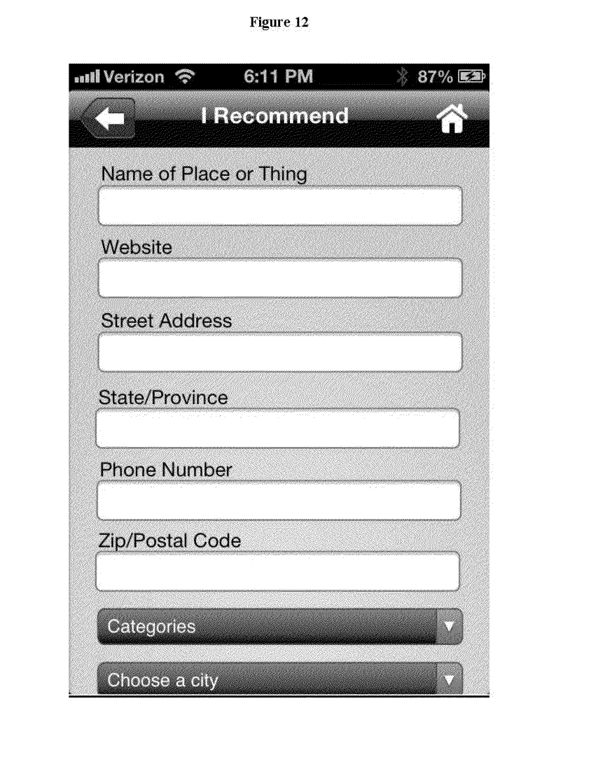

In some embodiments, the platforms, systems, software applications, media, and methods described herein comprise a software module in the mobile application to allow the mobile user to enter referral information. The referral information may contain a referee who is a potential mobile user. Referring to FIG. 11, in a particular embodiment, the mobile application shows an interface to allow the mobile user to enter referral information via social media, by way of non-limiting examples, such as Twitter and Facebook. In some embodiments, the referral information may contain a recommended attraction made by a mobile user. Referring to FIG. 12, the mobile application shows an interface to allow the mobile users to recommend an attraction/vendor.

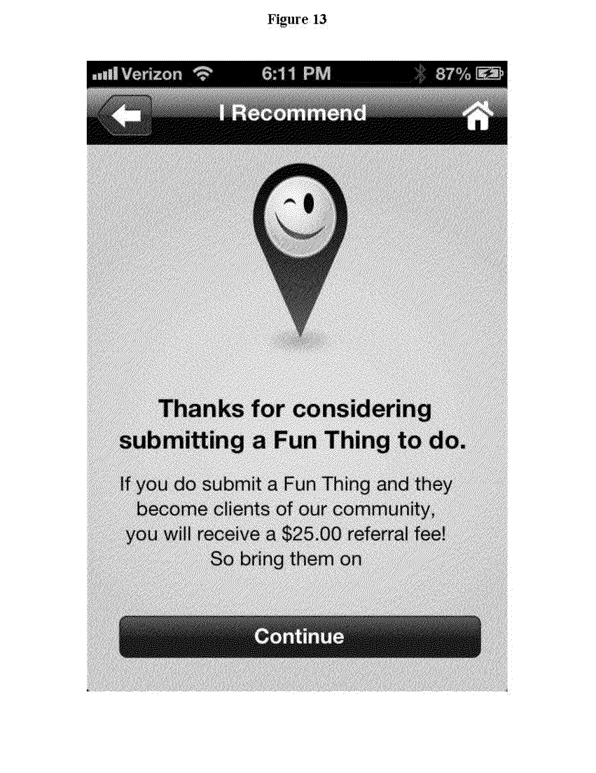

In some embodiments, the platforms, systems, software applications, media, and methods described herein comprise a software module in the server application to receive the referral information transmitted by the mobile application. The server may track if the referees have accepted the recommendations and started using the mobile application. The server may evaluate if a recommended attraction is a valid one and/or is worth being added into the databases. In some embodiments, based on the tracking and evaluation results, the server may pay the mobile user with a referral award to thank for the mobile user making the referral. The referral award may be, by way of non-limiting examples, an amount of money, a gift card, a coupon, a discount, or a combination of the same. Referring to FIG. 13, in a particular embodiment, the mobile received from the server an acknowledgement of making referral and a potential referral fee of $25 might be awarded to the mobile user.

### Digital Processing Device

In some embodiments, the platforms, systems, software applications, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the platforms, systems, software applications, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, software applications, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-in

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, software applications, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, software applications, media, and methods disclosed herein include one or more databases, or use of the same. In view of the disclosure provided herein, those of skill in the art will recognize that many databases are suitable for storage and retrieval of marketing, advertising and promotions information and companion information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Traveling with Family for a Vacation

A family living in Chicago planned to visit Boston for a vacation. With reference to FIG. 2, the dad used the mobile application to select “I′m with my family” and “I′m traveling” when departing from home. Meanwhile, the dad used the mobile application to find attractions in Boston of the children's greatest interests. When the flight landed in the airport of Boston, the just-in-time marketing, advertising and promotions platform identified the arrival of the family and sent out a marketing, advertising and promotions message to the dad regarding a map of the nearby museums. It happened that Boston Children's Museum was celebrating its 100^{th} anniversary and the admission tickets were 20% off. The mobile application further displayed this marketing, advertising and promotions message to the dad, so the whole family enjoyed an afternoon time in the Museum.

### Example 2

### Special Event Just-in-Time Marketing

The mobile application had known that the dad is a baseball fan from his demographic information when he set up the mobile application. One afternoon during the vacation, the mobile application further delivered a marketing message of a baseball event: Red Sox versus White Sox taking place in the evening. The dad was exciting to learn this information and brought the family to watch the ballgame.

### Example 3

### Referral System

During their stay in Boston, the dad exploited various marketing, advertising and promotions messages and made the trip with lots of fun. The dad loved the power of the mobile application helping him to finish a joyful trip, so he was eager to share his experiences of using the mobile application. With reference to FIG. 11, he recommended the mobile application through Facebook. On the other hand, the dad noticed that a restaurant where his family had a dinner provides fabulous gourmets, and believed many tourists would love the restaurant too. He used the mobile application, shown in FIG. 12, to recommend the restaurant.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A platform comprising:
(a) a processor configured to provide an enterprise user with an enterprise application comprising:
(i) a software module for configuring marketing, advertising and promotions information of an attraction to a mobile user and one or more companions of the mobile user;
(ii) a software module for summarizing the effectiveness of one or more marketing, advertising and promotions messages of the attraction to the mobile user and the one or more companions; and
(iii) a software module for recommending a marketing, advertising and promotions strategy to the mobile user and the one or more companions;
(b) a mobile processor configured to provide the mobile user with a mobile application comprising:
(i) a software module for tracking a location of the mobile user,
(ii) a software module for receiving demographic information of the mobile user,
(iii) a software module for gathering companion information of the mobile user
(1) by requesting the mobile user to indicate the companion information or
(2) by automatically detecting the presence of one or more companions physically traveling with the mobile user and performing one or more of the following actions:
identifying the purpose of the trip, recognizing the type of the companions, tracking a location of the companions, and collecting the demographic information of the companions, and
(iv) a software module for the mobile user to receive a marketing, advertising and promotions message of the attraction through a push notification without a human request, wherein the message provides the mobile user with attraction information suitable for the mobile user and the one or more companions; and
(c) a server comprising a processor configured to provide a server application comprising:
(i) a software module for receiving and storing the marketing, advertising and promotions information of the attraction provided from the enterprise application;
(ii) a software module for receiving and storing the location, the demographic information and the companion information of the mobile user provided from the mobile application;
(iii) a software module for creating a marketing, advertising and promotions message by instantly analyzing the location, the demographic information and the companion information of the mobile user and analyzing the marketing, advertising and promotions information of one or more attractions in the vicinity of the mobile user;
(iv) a software module for instantly delivering a push notification to the mobile user without a user request, the push notification containing the marketing, advertising and promotions message; and
(v) a software module for measuring the effectiveness of the marketing, advertising and promotions message by analyzing one or more behaviors of the mobile user and the one or more companions after receiving the marketing, advertising and promotions message.

2. (canceled)

3. The platform of claim 1, wherein the enterprise application further comprises a software module for processing a billing and payment of the attraction.

4. The platform of claim 1, wherein the companion information comprises an indication of the mobile user being alone or being with a companion.

5. The platform of claim 4, wherein the companion information further comprises the type of the companion if the mobile user is with a companion.

6. The platform of claim 1, wherein the gathering companion information is completed by receiving one or more inputs entered by the mobile user.

7. (canceled)

8. The platform of claim 1, wherein the marketing, advertising and promotions message is a text file, an audio file, an image, a video file, or a combination of the same.

9. The platform of claim 1, wherein the marketing, advertising and promotions message comprises a map of one or more attractions in the vicinity of the mobile user.

10. The platform of claim 1, wherein the marketing, advertising and promotions message comprises a location of an attraction in the vicinity of the mobile user.

11. The platform of claim 1, wherein the marketing, advertising and promotions message comprises an advertisement in the vicinity of the mobile user.

12. The platform of claim 1, wherein the marketing, advertising and promotions message comprises an event in the vicinity of the mobile user.

13. The platform of claim 1, wherein the marketing, advertising and promotions message comprises a product on sale in the vicinity of the mobile user.

14. The platform of claim 1, wherein the marketing, advertising and promotions message comprises a coupon offered by an attraction in the vicinity of the mobile user.

15. The platform of claim 1, wherein the analyzing one or more behaviors of the mobile user comprises tracking if the mobile user has entered the location of the attraction indicated in the marketing, advertising and promotions message.

16. The platform of claim 1, wherein the analyzing one or more behaviors of the mobile user comprises tracking if the mobile user has attended the event indicated in the marketing, advertising and promotions message.

17. The platform of claim 1, wherein the analyzing one or more behaviors of the mobile user comprises tracking if the mobile user redeemed a coupon indicated in the marketing, advertising and promotions message.

18. (canceled)

19. Non-transitory computer-readable storage media encoded with a computer program including instructions executable by a mobile processor to create a mobile application comprising
(a) a software module for tracking a location of a mobile user,
(b) a software module for receiving demographic information of the mobile user,
(c) a software module for gathering companion information of the mobile user
(i) by requesting the mobile user to indicate the companion information or
(ii) by automatically detecting the presence of one or more companions physically traveling with the mobile user and performing one or more of the following actions: identifying the purpose of the trip, recognizing the type of the companions, tracking a location of the companions, and collecting the demographic information of the companions, and
(d) a software module for the mobile user to receive a marketing, advertising and promotions message of an attraction through a push notification without a user request, wherein the message provides the mobile user with attraction information suitable for the mobile user and one or more companions.

20. Non-transitory computer-readable storage media encoded with a computer program including instructions executable by a server processor to create a server application comprising:
(a) a software module for receiving and storing the marketing, advertising and promotions information of one or more attractions, the marketing, advertising and promotions information provided by the one or more attractions;
(b) a software module for receiving and storing a location, demographic information and companion information of a mobile user, wherein the location, the demographic information and the companion information are provided through a mobile application
(i) by requesting the mobile user to indicate the companion information or
(ii) by automatically detecting the presence of one or more companions physically traveling with the mobile user and performing one or more of the following actions: identifying the purpose of the trip, recognizing the type of the companions, tracking a location of the companions, and collecting the demographic information of the companions;
(c) a software module for creating a marketing, advertising and promotions message by instantly analyzing the location, the demographic information and the companion information of the mobile user and analyzing the marketing, advertising and promotions information in the vicinity of the mobile user;
(d) a software module for instantly delivering a push notification to the mobile user, the push notification containing the marketing, advertising and promotions message, wherein the message provides the mobile user with attraction information suitable for the mobile user and one or more companions; and
(e) a software module for measuring the effectiveness of the marketing, advertising and promotions message by analyzing one or more behaviors of the mobile user and the one or more companions after receiving the marketing, advertising and promotions message.

21. The platform of claim 1, wherein the enterprise application further comprises a software module for the enterprise user managing one or more of the following: promotion offerings, price discounts, promotion timing, customer types, and locations of promotions.

22. The platform of claim 1, wherein the analyzing one or more behaviors of the mobile user comprises evaluating a review of the mobile user on one or more of the following: promotions of an attraction, quality of an attraction, and experiences of the mobile user.
